(19) United States
(12) Patent Application Publication
(10) Pub. No.: US 2015/0224550 A1
(43) Pub. Date: Aug. 13, 2015

(54) AUTOMATIC pH BALANCING SYSTEM

(71) Applicant: Don Frazier, Wimberley, TX (US)

(72) Inventor: Don Frazier, Wimberley, TX (US)

(21) Appl. No.: 14/179,386

(22) Filed: Feb. 12, 2014

(51) Int. Cl. B09C 1/08; E21B 49/00; A62D 3/36

(52) U.S. Cl. CPC B09C 1/08; A62D 3/36; E21B 49/005

(57) ABSTRACT

A system is provided for altering the pH of a drilling mud while minimizing risk of injury. The system comprises a mobile transport comprising a container holding a pumpable agent having a known pH that is dispensed from the container through a first conduit by a pump that is regulated by a controller that controls the pump's feed rate and power. The controller receives pH information from a sensor within the mud in real-time. A method of administering a pumpable agent for adjusting the pH of a drilling mud in a mud pit is provided. The method involves mixing a pH adjusting agent with a carrier or liquid offsite from the mud pit to form a pumpable agent, adding the mixture to a transportable container, and transporting the container to the mud pit, and adding the agent to the mud pit to adjust the pH of the mud.

### FIELD OF THE INVENTION

The present invention relates to a system for monitoring and controlling the pH of drilling fluids, particularly fluids used in drilling for oil and gas.

### BACKGROUND OF THE INVENTION

Hydrocarbon wells are drilled into the earth or seabed using a drilling rig which rotates a drill string having a drill bit attached at the downhole end. As upper portions of the wellbore are drilled, then cased or lined with tubulars, the effective diameter of the wellbore becomes progressively smaller, and correspondingly smaller drill strings and bits are used to pass through the uphole casings. This is referred to as having the wellbore “step down” to progressively smaller diameters.

During drilling operations, drilling fluid is stored and circulated from a mud pit or mud tank at the surface, downhole through the drill string to the drill bit at the downhole end, back uphole to the surface through the wellbore annulus, and then back to the mud pit for treatment and recirculation. The drilling fluid lubricates the drill string and bit, maintains hydrostatic pressure in the wellbore, and carries rock cuttings out of the wellbore.

The drilling fluid can be water-based or oil-based. Oil-based fluids tend to have better lubricating properties than water-based fluids, nevertheless, other factors can mitigate in favor of using a water-based fluid. In addition, the drilling fluid may be viscosified, for example, with polymers, to help suspend and carry rock cuttings out of the wellbore. An example of a water-based drilling fluid is a drilling mud which includes an aqueous solution and un-dissolved solids (solid suspensions). Both the dissolved solids and the un-dissolved solids can be changed to control the density of the drilling fluid.

Drilling muds typically comprise gelling agent, weighting agent, water, and additives. Additives are employed to control fluid properties, such as viscosity, yield point, gel strength, fluid loss, lubrication, and cooling and heat transfer properties. The effectiveness of many additives is controlled by the pH of the drilling mud, and monitoring of the pH is needed to ensure the mud's usefulness and prolong its utility. Moreover, as agents and additives are added, lost, and degraded during use, the pH of the mud changes, typically becoming more acidic.

Personnel, such as a “derrick hand” or drilling fluid engineer, measure the current drilling mud properties, in particular the pH, so the properties and pH may be adjusted. The pH is typically measured by hand at discrete time intervals, typically the drilling fluids engineer measures the pH once a day and the derrick hand measures the pH once an hour. Measurement inaccuracies are attributable to mechanical error, human error, and environmental conditions. Moreover, there may be significant delay in transmitting measured data to operator personnel who can adjust or authorize adjustment of the pH. Such delay can affect mud quality and adversely affect drilling operations, for example, by premature lubricant degradation, water loss polymer development, etc.

The pH of the drilling mud is conventionally adjusted by hand by adding a dry, high-pH agent (sometimes a low pH agent is used) to the mud pit or tank. For example, to raise the pH of the mud, one or more bags of a strong base, such as caustic soda (sodium hydroxide), are added to the mud pit. While protective clothing is recommended or required during this procedure, since caustic soda is a Category 8 Hazardous Material, it is often infeasible or inconvenient given the extreme temperatures and conditions at many drilling sites. Mud personnel often risk serious injury from bumps caused by contact or inhalation of the caustic agent.

Thus, there is a need for a system to monitor the pH of the drilling fluid in a mud pit, in real-time, and automatically adjust the pH on-site without requiring manual intervention. Similarly, there is a need for a system where a pH-adjusting mixture is prepared off-site for subsequent use at a mud pit.

### SUMMARY OF THE INVENTION

A system is described for the altering of the pH of a mud in a mud pit. The system comprises a mobile transport comprising at least one container having a pumpable agent at a predetermined pH. The pumpable agent is dispensed from the container via a first conduit by a pump that is operable communication with a controller that sends instructions to the pump which regulate the pump's feed rate and power. The controller is in electronic communication with a pH sensor located within the mud and monitors the pH in real-time. The system provides for rapid adjustment of pH that permits the pH to be maintained within a narrow range. In some embodiments, the first conduit includes a safety valve and/or a mixer. In alternate embodiments, the controller alters an operator when the pH exceeds the predetermined pH limit. In a preferred embodiment, the system further comprise a remote computer and the controller sends data to the remote computer.

A method is also described that improving the accuracy of the pH of a mud in a mud pit and reducing the risk of injury to an operator that comprises providing the system described above, obtaining a pH reading of the mud; comparing the pH reading to a predetermined pH range; and adjusting the feed rate of the pump to dispense the pumpable agent into the mud, thereby raising or lowering the pH of the mud to a predetermined pH range.

In a preferred method, the pumpable agent is prepared offsite, added to at least one container, transported to the mud pit, and hooked up to a first conduit by a pump that is operable communication with a controller that sends instructions to the pump which regulate the pump's feed rate and power. The controller is in electronic communication with a pH sensor located within the mud and monitors the pH in real-time. The system provides for rapid adjustment of pH that permits the pH to be maintained within a narrow range. In some embodiments, the first conduit includes a safety valve and/or a mixer. In alternate embodiments, the controller alters an operator when the pH exceeds the predetermined pH limit. In a preferred embodiment, the system further comprise a remote computer and the controller sends data to the remote computer.

Alternate embodiments are described and these and other features, advantages, benefits and objectives of the present invention will become apparent to one of ordinary skill in the art upon careful consideration of the detailed description of representative embodiments of the invention herein below and the accompanying drawings.

### BRIEF DESCRIPTION OF THE DRAWINGS

For a more complete understanding of the present invention and for further advantages thereof, reference will now be made to the following Detailed Description taken in conjunction with the accompanying Drawings in which:

FIG. 1 is schematic representation of a preferred embodiment of the automated pH balancing system of the present invention; and

FIGS. 2A-2C depict embodiments of the pH sensor (A), controller (B), and an air blast cleaning system (C) for cleaning the pH sensor.

### DETAILED DESCRIPTION OF THE PREFERRED EMBODIMENT

The words or terms used herein have their plain, ordinary meaning in the field of this disclosure, except to the extent explicitly and clearly defined in this disclosure or unless the specific context otherwise requires a different meaning.

If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed. As used herein, the words “consisting essentially of,” and all grammatical variations thereof are intended to limit the scope of a claim to the specified materials or steps and those that do not materially affect the basic and novel characteristic(s) of the claimed invention.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

Terms such as “first,” “second,” “third,” etc. may be assigned arbitrarily and are merely intended to differentiate between two or more components, parts, or steps that are otherwise similar or corresponding in nature, structure, function, or action. For example, the words “first” and “second” serve no other purpose and are not part of the name or description of the following name or descriptive terms. The mere use of the term “first” does not require that there be any “second” similar or corresponding component, part, or step. Similarly, the mere use of the word “second” does not require that there be any “first” or “third” similar or corresponding component, part, or step. Further, it is to be understood that the mere use of the term “first” does not require that the element or step be the very first in any sequence, but merely that it is at least one of the elements or steps. Similarly, the mere use of the terms “first” and “second” does not necessarily require any sequence. Accordingly, the mere use of such terms does not exclude intervening elements or steps between the “first” and “second” elements or steps, etc.

As used herein, a “fluid” broadly refers to any fluid adapted to be introduced into a well for any purpose. A fluid can be, for example, a drilling fluid, a setting composition, a treatment fluid, or a spacer fluid.

As used herein, “mud pit” refers to a suction pit, a settling pit, or a storage tank (such as a frac tank), earthen dams for inner and outer reserve pits, and the like, as known to one of ordinary skill in the art.

“Drilling fluids”, also known as “drilling muds” or simply “muds,” are typically classified according to their base fluid, that is, the nature of the continuous phase. A water-based mud (“WBM”) has a water phase as the continuous phase. In some cases, oil may be emulsified in a water-based drilling mud. An oil-based mud (“OBM”) has an oil phase as the continuous phase.

As used herein, an agent (e.g., mixture, fluid, solution, powder, etc.) is considered to be “pumpable” so long as it has an apparent viscosity of less than 30,000 mPa·s (cP).

“On-site” as used herein means at the mud pit or tank.

“Offsite” as used herein means at a location different from the mud pit or tank. In some embodiments, “offsite” can be further defined as being at least 50 feet from the mud pit or tank, at least 100 feet, at least 250 feet, at least 500 feet, at least 1,000 feet, at least one-half mile, or at least one mile, from the mud pit or tank.

“Real-time” as used herein refers to the actual time during which a process takes place or an event occurs and updates data regarding the process as soon as it is received from the source from which the data is sent or obtained from.

While the making and using of various embodiments of the present invention are discussed in detail below, a practitioner of the art will appreciate that the present invention provides applicable inventive concepts, which can be embodied in a variety of specific contexts. The specific embodiments discussed herein are illustrative of specific ways to make and use the invention and do not delimit the scope of the present invention.

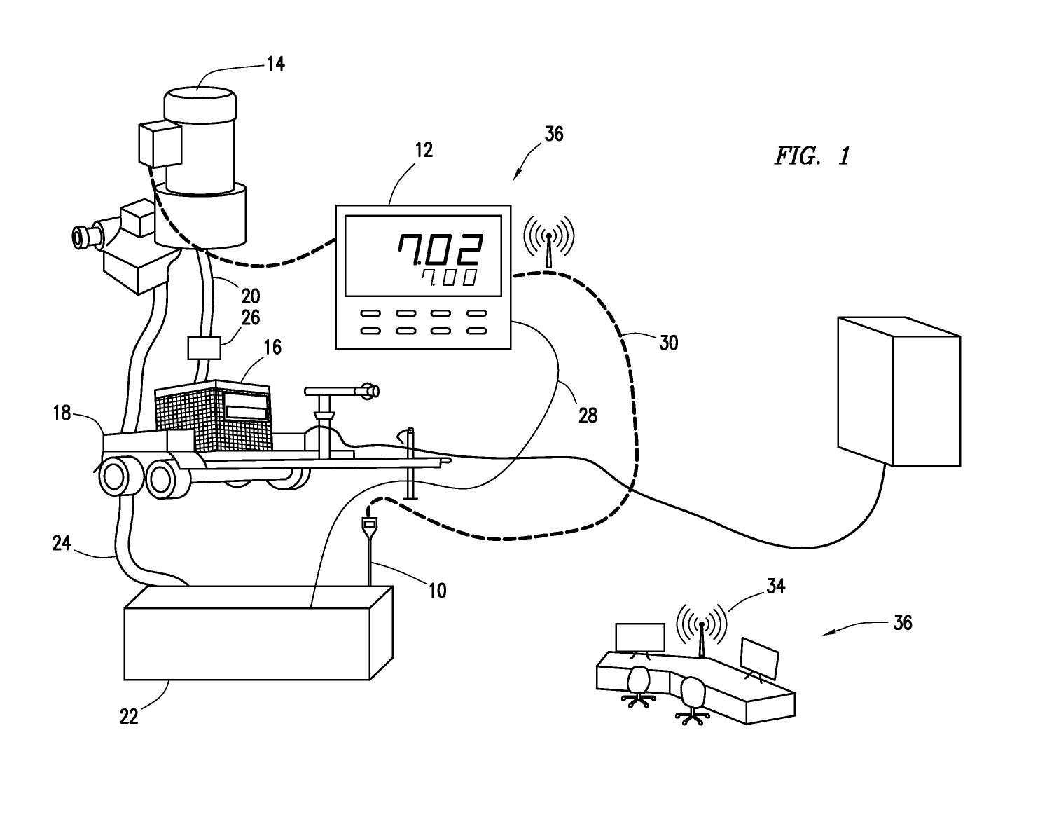

FIG. 1 is a schematic representation of an embodiment according to an aspect of the invention. As shown in FIG. 1, the pH of the drilling mud in the mud pit is sensed and/or measured by a pH sensor or probe 10 in operable communication with a controller 12. The controller is, in turn, in operable communication with a pump 14. The pump 14 receives a pumpable agent from a container 16 located on a mobile transport 18 via a first conduit 20 and pumps the agent to the mud pit 22 via a second conduit 24. As also shown in FIG. 1, a safety valve 26 may be located along the first conduit 20 between the container 16 and the pump 14 and at other locations along the fluid control system.

According to one aspect of the invention, the pH adjusting agent is prepared offsite in a manner that would not require an operator to be exposed to a toxic agent that could cause burns or toxicity upon inhalation or contact with the skin or mucosa at the mud pit. The offsite location includes a warehouse or shop or other structure that provides a suitable work environment for reducing the risk of injury otherwise present during mixing on-site at a mud pit. For example, proper clothing and materials are stored in the structure and necessary materials are available that maximize the protection to an operator. The pH adjusting agent is stored within or near the structure so that access to proper protective clothing is more convenient and therefore increasing the likelihood that the clothing will be worn. Therefore the material can be handled without the inconvenience associated with mixing on-site at the mud pit.

The “pH adjusting agent” as defined herein includes any base that is used to adjust the pH of a drilling mud, and in one aspect of the invention the pH adjusting agent is a strong base that is readily soluble in water, ethanol or methanol to form a liquid. Examples include caustic soda (sodium hydroxide) and lime (calcium-containing inorganic materials). Alternatively, the pH adjusting agent is an acid such as, for example, hydrochloric acid. The pH adjusting agent can be combined with a carrier fluid to form a carrier solution for subsequent addition as a pumpable agent to the mud. Suitable mixtures may be mixtures of several different compounds, including but not limited to, mixtures of caustic soda and water, lime and water, hydrochloric acid and water, etc. The pH of the pumpable agent may be determined after the mixing is completed or the desired final pH of the pumpable agent is determined prior to its preparation.

After mixing, the pumpable agent is added to a transportable container 16, such as a tote tank for relocation to mud pit 22. In preferred examples the container is a 275 or 330 gallon tote tank, which can be easily loaded on a form of transportation 18, (e.g., a truck or trailer or similar means of transportation) for relocation to the mud pit 22 for addition to the mud when needed, i.e., when the mud pH exceeds a predetermined range. The desired pH of the mud is about 7 to about 14. The mud pH is preferably about 9 to about 11, and more preferable ranges include about 9.5 to about 10, about 10.5 to about 11.5, and about 10.5 to about 12. By way of example, the predetermined range may be any of these ranges or any range within or overlapping these exemplary ranges.

In an alternate embodiment, multiple containers are each filled offsite with one of the compounds or agents prior to transportation to the mud pit 22 and transported in separate containers but may be transported together, for instance, on or by the same means of transportation. Once on-site, conduits from each container (16a, 16b) feed into a receptacle or third empty container (16c) containing a mixer, if needed, and the receptacle or third container (16c) is in communication with the pump via the first conduit 20. The features of the other embodiments can be used with this embodiment as well.

The current use of test strips require taking a sample by hand, dipping the strip into a sample, pulling the strip out and comparing the color produced by the sample to known standards. It is therefore dependent on ambient light conditions, the color vision of the operator, and because it is subjective, raises the possibility of bias that is nonexistent with electronic sensing. A pH sensor that does not require a visual color comparison, or more particularly, an operator's subjective determination is therefore desirable.

The pH sensor 10 electronically detects the pH of the mud in the mud pit 22 in real-time and without requiring operator action or analysis and conveys that information to the controller 12. The pH sensor 10 communicates with a controller locally or offsite by wire 28 or wirelessly 30. Various pH sensors are well known in the art and are available from a variety of manufacturers, including for example, Hach Company (Loveland, Colo.). In a further aspect of the invention, pH sensor 10 automatically shuts off in the event that it is exposed to air, and sends a signal to the controller 12 which in turn sends an alert to a PDA or similar device worn by the operator, thereby notifying the operator of the problem.

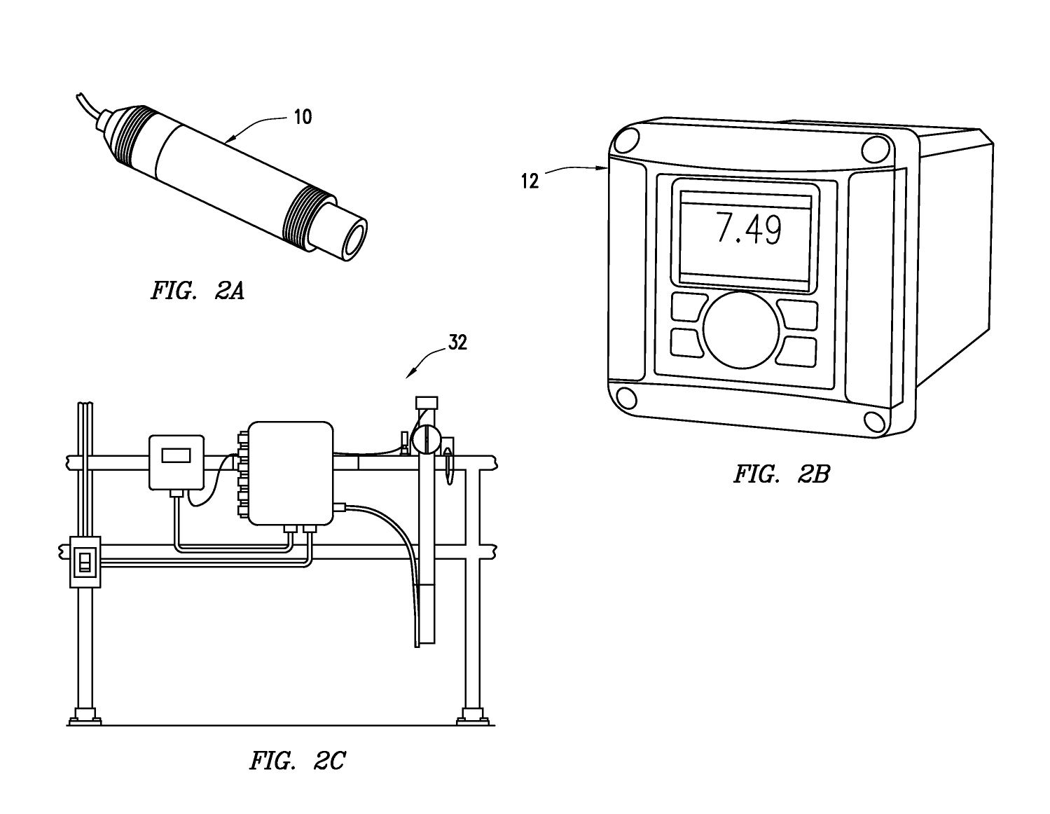

In a further embodiment, the pH sensor 10 may be cleaned via an air blast system 32, such as that depicted in FIG. 2C, occasionally to maintain its accuracy by removing any mud caked on the sensor that potentially interferes with acquiring accurate pH readings. A tube from the airblast system 32 is located next to the pH sensor and air is blown at regular (or irregular) intervals, for example, every four hours, that cleans off any material that has accumulated on the pH sensor.

### Controller

The pH sensor 10 sends data to the controller 12. A preferred controller is the SC200™ Universal Controller by Hach Company (Loveland, Colo.). The controller 12 is also in operable communication with a computer 34, including for example a personal computer or device (PC, PDA, or similar device known in the art). The controller may be programmed by the computer 34, which may be offsite including a remote location, to set predetermined lower and/or upper pH limits of the mud and the controller 12 sends status information to the computer 34 regarding the pH of the mud. When the pH of the mud falls below, for example, a pH of 7, the controller 12 automatically sends an alert to the computer/device 34, thereby notifying the operator of the mud's current pH status in real-time. While the controller 12 automatically monitors and controls the pH of the mud, the operator can provide input to the controller 12 by wireless signal from the operator's personal computer or device 34. Another operator may also monitor and override the operator's input or the controller's programmed predetermined pH limits using similar methods.

The controller 12 is in operable communication with the pump 14. The controller 12 sends a signal to the pump 14, which is able to receive and respond to the controller via a receiver/transmitter (not shown), as well as to send a feedback signal to the controller, for example, to provide status information.

The controller 12 receives measurements taken by the pH sensor 10 in real-time and compares it to the specified pH range, and if the input is greater or lower than the specified pH range, the controller 12 sends a pH regulating signal that turns the pump on or off. For instance, where the pump 14 is on and the pH is higher than the upper limit, the controller 12 sends a pH regulating signal that slows the pump's feed rate or turns the pump off in order to reduce the amount of pumpable agent delivered to the mud that would otherwise continue to lower its pH. Conversely, where the pump 14 is off and the pH is too low, the controller 12 turns the pump on to deliver additional pumpable agent to raise the pH of the mud. Depending on the solubility of the pH adjusting agent, a mixer 36 may be provided. The mixer 36 is preferably located within or at least partially insertable within the container 16, but can be inline with the first conduit 20 as it extends from the container 16 to the pump 14, to ensure that the pumpable agent is at the correct pH and minimize the need for fine-tuning of the pH and therefore additional adjustments. The advantage of having a pH sensor provide real-time pH measurements to the controller is that it allows the controller to adjust the mud pH (via the pump and pumpable agent) in real-time, thereby maintaining the mud's pH in a narrow range that extends the life of the mud and reduces downtime in drilling and therefore reduces operating costs, while not requiring operator intervention on-site.

Wireless communication can be used to allow data collection and system operation by a remote user via a remote database, computer, wireless device, network or other system. Wireless communication can be used between the controller and the remote user's system, between the pump(s) and the user, the probes or sensors and the user, or a combination of these. As an example, Hach's SC1000 Multi-parameter Universal Controller is a state-of-the-art modular controller system having direct capacity for use with eight sensors. The SC1000 consists of a Display Module and one or more Probe Modules. The Display Module has a touch-screen user interface that can be used for any number of parameters. One Display Module controls one or several Probe Modules connected by a digital network. The Display Module is fully portable and can be disconnected and moved anywhere within the network. The Display Module can have GSM/GPRS, Ethernet, RS232, RS485, TCP/IP, or other similar capability. The Probe Modules can provide power to the system. Alternately, a wireless module can be later added to a controller not having such capability. The remote user is able to receive and review pH readings (and other parameters if desired) and, preferably, also remotely change acceptable parameters and parameter ranges. Further, the user can, via the remote communication system between the user and controller, operate the pH (or other) pump, including control of turning on and off the pump, changing the pump rate, pump throttle, clutch actuator, etc.

The embodiments shown and described above are exemplary. It is not claimed that all of the details, parts, elements, or steps described and shown were invented herein. Even though many characteristics and advantages of the present inventions have been described in the drawings and accompanying text, the description is illustrative only. Changes may be made in the detail, especially in matters of arrangement of the parts or steps within the scope and principles of the inventions. The restrictive description and drawings of the specific examples above do not point out what an infringement of this patent would be, but are to provide at least one explanation of how to use and make the inventions. The limits of the inventions and the bounds of the patent protection are measured by and defined in the following claims.

What is claimed is:

1. A system for monitoring and adjusting the pH of a mud pit comprising:
a mobile transport comprising at least one container comprising a pumpable agent at a predetermined pH;
a controller in electronic communication with a pH sensor located within the mud pit.
a pump having a first conduit in communication with the at least one container and being in operable communication with the controller and controls flow of the pumpable agent from the at least one container.

2. The system of claim 1, wherein the pH sensor detects the pH of the mud in real-time and sends a pH signal to the controller.

3. The system of claim 1, wherein upon the pH exceeding a predetermined range the controller sends a regulatory signal to the pump that controls release of the pumpable agent into the mud pit.

4. The system of claim 1, wherein the pH of the mud is maintained within a predetermined pH range.

5. The system of claim 4, wherein the pH range is about 9 to about 14.

6. The system of claim 1, wherein the controller sends an alert to an operator when the pH exceeds at least one predetermined limit.

7. The system of claim 1, wherein the controller regulates the feed rate of the pump to control release of the pumpable agent.

8. The system of claim 1, wherein the controller turn the pump on or off.

9. The system of claim 1 wherein the communication between the controller and the pump is wireless.

10. The system of claim 1, further comprising a computer.

11. The system of claim 10, wherein upon the pH exceeding a predetermined range, the controller sends data to the computer.

12. The system of claim 1, wherein the pH sensor turns off after a defined delay after withdrawal from the mud.

13. The system of claim 1 further comprising a safety valve between the at least one container and the pump.

14. The system of claim 1, wherein the pumpable agent is a mixture.

15. The system of claim 14, wherein the mixture is a liquid or a suspension.

16. The system of claim 15, wherein the mixture is prepared offsite from the mud pit.

17. The system of claim 14, wherein the mixture is prepared by mixing a pH adjusting agent and a liquid.

18. The system of claim 1, wherein the pH adjusting agent has a pH greater than 7.

19. The system of claim 17, wherein the pH adjusting agent is caustic soda or lime.

20. The system of claim 1, wherein preparing the mixture offsite reduces the risk of injury to an operator, increases the likelihood that the pH of the mud is within a predetermined range, or reduces the cost of drilling operations, or a combination thereof, compared to adding the pH adjusting agent directly to the mud.

21. A method of improving the accuracy of the pH of a mud in a mud pit and reducing the risk of injury to an operator, the method comprising:
providing the system of claim 1;
obtaining a pH reading of the mud;
comparing the pH reading to a predetermined pH range; and
and adjusting the feed rate of the pump to dispense the pumpable agent into the mud, thereby raising or lowering the pH of the mud to a predetermined pH range.

22. A method of administering a pumpable agent for adjusting the pH of a drilling mud in a mud pit, the method comprising:
mixing a pH adjusting agent with a carrier or liquid offsite from the mud pit to form a pumpable agent;
adding the mixture to at least one transportable container; and
transporting the at least one transportable container to the mud pit,
adding the pumpable agent to the mud to adjust the pH.
